(19) United States
(12) Patent Application Publication
(10) Pub. No.: US 2006/0017662 A1
(43) Pub. Date: Jan. 26, 2006

(54) Method for improving the perceived resolution of a colour matrix display

(75) Inventors: Rob A. Beuker, Best (NL); Michiel A. Klompenhouwer, Breda (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/537,448

(22) PCT Filed: Nov. 27, 2003
(86) PCT No.: PCT/IB03/05486

§ 371 Date: Jun. 2, 2005

(30) Foreign Application Priority Data
Dec. 4, 2002 (EP) 02102681.0

(51) Int. Cl. G09G 3/28

(52) U.S. Cl. 345/72; 345/88

(57) ABSTRACT

This invention relates to a method for improving the perceived resolution of a colour matrix display with at least one pixel, comprising the steps of subdividing an incident colour channel signal (R) to said pixel into a first and second signal component (R1, R2), applying a gain factor (CR) to one of said signal components (R1, R2), and-subsequently recombining said first and second signal components (R1, R2) into an exiting, modified colour channel signal (R′).

This invention relates to a method for improving the perceived resolution of a colour matrix display. The invention also relates to such a colour matrix display.

Colour matrix displays are increasingly entering the market, and are used in a wide range of applications, both in television and personal computer monitors and in handheld systems. Examples of such colour matrix display technologies are plasma display panels, liquid crystal displays, polymer light emitting displays, organic light emitting displays, and so-called FIT displays. Colour matrix displays usually have a fixed relationship between the visible pixels and the digital driving signal. One way of building such a matrix display is to arrange a plurality of columns on the display surface, each column being arranged to display one colour. By interspersingly arranging columns of different colours, such as red, green and blue, a column-based RGB display is achieved. However, a problem with this prior-art colour matrix display is that the total number of columns of the display is a factor three larger than the total number of pixels per line. Thereby, all columns are not used to generate luminance information, while the sharpness impression is determined by the luminance portrayal. Moreover, a problem with prior art colour matrix displays is that the position of the colour sub-pixels usually is not considered in the processing of the signal that is to be displayed. An example of such processing is scaling. By not considering the position of the sub-pixel, luminance-to-luminance aliasing will occur, and furthermore, filtering of the baseband signal will occur.

One way of trying to solve this problem is disclosed in the article M. A. Klompenhouver, G. de Haan, R. A. Beuker, ‘Sub-pixel image scaling for color matrix displays’ SID2002, pp 176-179. According to this document, scaling may be performed with a proper phase shift/delay of the colour signals, taking into account the location of the subpixels on the screen.

However, a problem with this prior art solution is that the aliasing is not avoided, even if filtering of the base-band signal is absent. Hence, an alternative solution for avoiding luminance-to-luminance aliasing is desired.

Hence, an object of the present invention is to provide a colour matrix display, as well as a method, in which the above-mentioned aliasing problems are avoided, whereby the perceived resolution of the display is improved.

This and other objects are at least in part achieved by a method as described by way of introduction, comprising the steps of subdividing an incident colour channel signal to said pixel into a first and second signal component, applying a gain factor to one of said signal components, and subsequently recombining said first and second signal components into an exiting, modified colour channel signal. Thereby, luminance aliasing being the most visible term, as will be closer described below, is avoided, and hence the perceived resolution is improved. Suitably, said first and second signal components are a low-pass component and a high-pass component, respectively, and most preferably, said gain factor is applied to said high-pass component.

Moreover, the low-pass component is suitably realised by means of a low-pass filter, and said high-pass component is realised by means of a high-pass filter, said low-pass and high-pass filters being complementary. Preferably, the gain factor is provided, so that the gain factor is inversely proportional to the contribution of the colour channel to the total luminance of the colour matrix display. Also, the method suitably further comprises the step of: transmitting said exiting, modified colour channel signal to a delay and up- or downsampling block in order to provide the modified colour channel signal with a suitable delay and scaling. The delay and up- or downsampling block is for example arranged to provide suitable delays for a set of signals, such as an (R,G,B) signal set.

The above and other objects are also achieved by a colour matrix display device having at least one pixel, said pixel being arranged to be controlled by means of an applied colour channel signal, the display device having a control unit comprising a subdivision unit, for subdividing an incident colour signal into a first and second signal component, a gain factor application unit, for applying a gain factor to one of said components, and a recombination unit, for subsequently recombining said first and second signal components into an exiting, modified colour channel signal, being used to control said pixel. Also in this case, luminance aliasing being the most visible term, as will be closer described below, is avoided, and hence the perceived resolution is improved.

The invention will hereinafter be described by means of preferred embodiments thereof, with reference to the accompanying drawings.

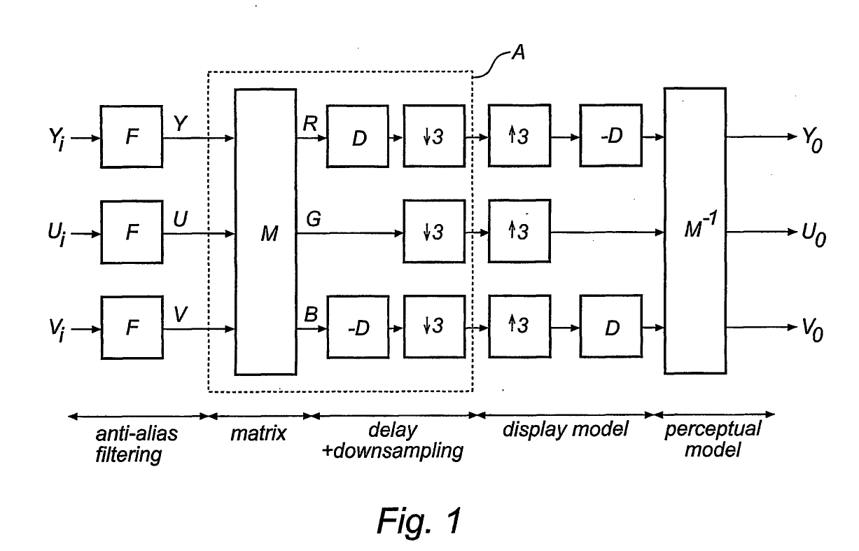

FIG. 1 discloses a basic model of an RGB display pixel driving circuit that may include the inventive sub-pixel shift.

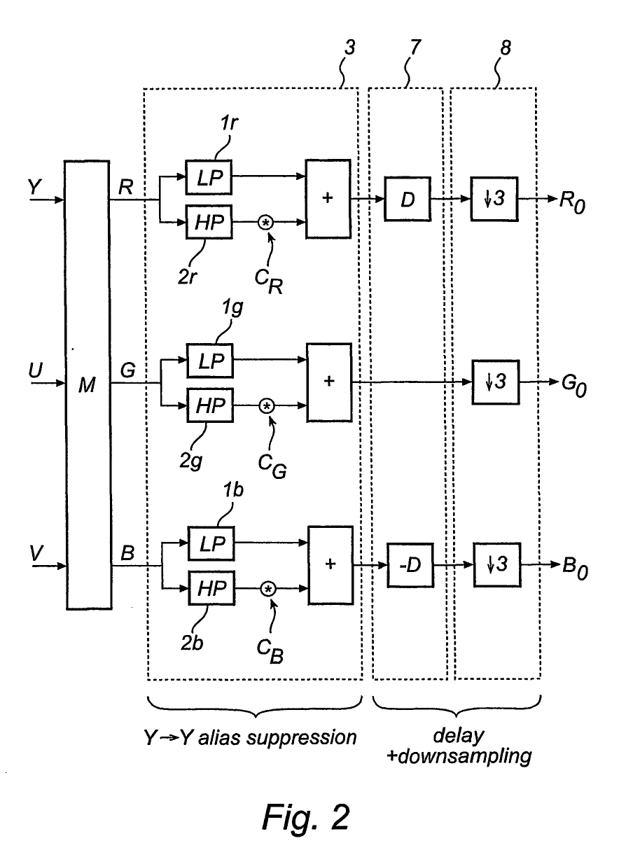

FIG. 2 discloses a part of the model disclosed in FIG. 1, in which the invention is incorporated.

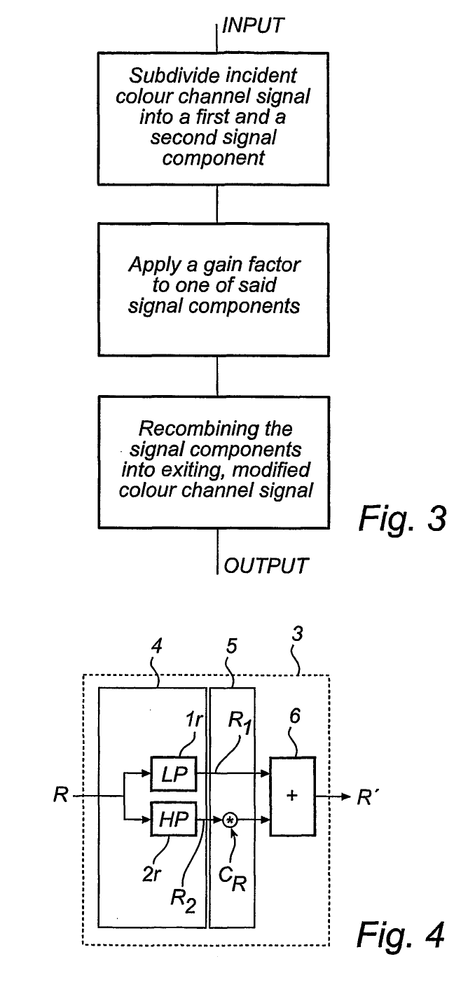

FIG. 3 discloses a basic flow chart of the method in accordance with the invention.

FIG. 4 discloses in greater detail one single colour signal (in the present case R) of the part disclosed in FIG. 2.

One embodiment of the invention will hereinafter be described in closer detail. This embodiment is chosen to provide a straight-forward analysis of the problem, and is not to be regarded as limiting for the scope of the invention.

For this embodiment of the invention, the following assumptions will be made.
The display is a column-based RGB colour matrix display, i.e. a display in which each column contains one colour (in this case red, green or blue).
The display colours are FCC RGB primary colours. This assumption makes the analysis more readable.
The colours are column-based. Hence, for analysing filtering and aliasing, we only need to consider the horizontal axis, i.e. one line.
Each line has N RGB samples, so the display has 3N columns.
The RGB signals used in the display are properly pre-processed in accordance with prior art, so that the phase of the signals corresponds to the display position, i.e. the subpixel position on the display surface.
The display is linear, i.e. exhibits no gamma. If the display has gamma, the below analysis may be seen as an approximation.
The input signal consists of 3N RGB samples. Hence, the input signal need to be downsampled by three to obtain the display resolution. This makes the math more readable, but any other downsampling factor essentially yields the same conclusions. However, the method is also applicable to other up- or downsampling factors. An efficient implementation for integer or non-integer sampling factors may be given by means of so-called polyphase filters.
The FCC YUV is a perceptual relevant space, so these signals will be used as a basis for the analysis.

The underlying idea behind the present invention is to, by means of processing, put sub-pixels of source signals at a right position, and according to the invention, this is implemented by means of a sub-pixel shift.

A basic prior art model that may be modified to include the inventive sub-pixel shift is disclosed in FIG. 1. The model is built up to model a set of three columns, a red, a blue and a green column. The model essentially comprises three branches, one for each primary colour R, G and B. A signal package {Yᵢ,Uᵢ,Vᵢ}, where Yᵢ is a digital luminance signal while Uᵢ and Vᵢ are digital colour difference signals, is inputted to the modelled system to an anti-alias filtering block F. The anti-alias filtering block F limits the aliasing due to downsampling by a factor three (see the list of assumptions above). From the anti-alias filtering block F, signals {Y,U,V} are outputted and is subsequently inputted into a common matrix block M. The matrix block is arranged to convert the inputted signals {Y,U,V} into an RGB signal package {R,G,B} and the conversion matrix M is given by equation 1 below.

$$M = [ \begin{matrix}1 & 0 & 1.4025 \\ 1 & - 0.3443 & - 0.7144 \\ 1 & 1.773 & 0\end{matrix} ] \qquad ( 1 )$$

The {R,G,B} signals generated be the above conversion are inputted into a delay and downsampling block, comprising a delay block, where in this case the signal R is confronted with a delay factor D, the signal B is confronted with a delay factor −D, and the signal G remains unchanged. This delay is arranged to compensate for the display position, i.e. provide a sub-pixel shift. Thereafter, the {R,G,B} signals are inputted to the downsampling block, where all three signals are downsampled with a factor three, which reduces the input resolution of the display. Subsequently, the signal package is inputted to a display model block, essentially comprising upsampling blocks, arranged to upsample each signal of the package with a factor three, and a delay block, where in this case the signal R is confronted with a delay factor −D, the signal B is confronted with a delay factor D, and the signal G remains unchanged. The display model block is arranged to model the fact that each column can only display one colour (red, green or blue) in a repetitive pattern. After the display model block, the signals are inputted to a common inverse matrix block M⁻¹, given by equation 2.

$${M}^{- 1} = [ \begin{matrix}0.299 & 0.587 & 0.114 \\ - 0.169 & - 0.331 & 0.5 \\ 0.5 & - 0.419 & - 0.081\end{matrix} ] \qquad ( 2 )$$

The inverse matrix block M⁻¹ may be said to form a perceptual model block, and the signal package outputted from said block is denoted {Y₀,U₀,V₀}.

For the below analysis leading to the invention, the signal package {Y,U,V} will be used as a basis, where:
{Y,U,V}=F{Yᵢ,Uᵢ,Vᵢ} (3)

It may be shown that the digital luminance signal Y₀ resulting from the above model equals: Y[Z]=y[Z]+c₁y[z+*3 c;Y[Z -]+C₂U[Z+23]+C₂U[Z -23-]+C (4)

Hence, the resulting luminance signal Y₀ is equal to the baseband input luminance Y, plus alias terms. The alias terms are depending on the signals Y, U, and V and the complex constants cᵢ. In a corresponding way, as indicated by equation 4, the resulting digital colour difference signals U₀ and V₀ are equal to the baseband signals U and V, respectively, plus any alias terms. The alias terms are the sum of aliased versions of the signals Y, U, and V, multiplied by non-zero complex constants, in the corresponding way as in equation 4. Moreover, it shall be noted that the values of the complex constants cᵢ are dependent upon the matrices M and M⁻¹, as defined under equations (1) and (2) above.

However, it has been shown that a human eye is most sensitive to luminance aliasing, i.e. aliasing of the digital luminance signal Y. In particular, it may be shown that aliasing of the signal Y₀ due to the aliasing term

$$Y [ z \pm \frac{2 π}{3} ]$$

is the most visible.

Hence, this invention is based on the realisation that the effect of the matrix M, as described above, may be effectively modified in such a way that the constants of the aliasing term

$$Y [ z \pm \frac{2 π}{3} ]$$

becomes zero, and thereby the most visible aliasing terms may be deleted, improving the perceived sharpness of the display. According to the invention this is accomplished by adding a gain factor to each of the R, G and B channels. This is showed in detail in FIG. 2, and in more detail in FIG. 4 (only disclosing one of the channels (R), but the remaining channels (G,B) are similar). FIG. 2 only discloses a modification of the part denoted A in the model disclosed in FIG. 1. The rest of the model remains unchanged as disclosed in FIG. 1. In the sub-system disclosed in FIG. 2, the signal package {Y,U,V} is inputted in the matrix M, as described above and as defined in equation 1. From the matrix M, an {R,G,B} signal is outputted. Thereafter, in accordance with the invention, each signal (R, G or B) is split into a first and a second component, namely a high-pass and a low-pass component. This is accomplished by arranging a splitter (not explicitly shown) and subsequently a high-pass and a low-pass filter (1, 2), respectively, the splitter and the filters together forming a subdivision unit (4). The low-pass and high-pass filters are complementary, i.e. lp(z)+hp(z)=1. In order to avoid changing the colour purity, i.e. the colour rendition for large areas, for each signal (R, G or B), the gain factor C; as described above is applied only to the high-pass component (2r, 2g, 2b). This in achieved by means of a gain factor application unit 5, as disclosed in FIG. 4 for one of the channels (the remaining channels look similar). The resulting high-pass component and the low-pass component is thereafter recombined by means of an addition block or recombination unit 6, whereafter the resulting signal is outputted to the delay and downsampling blocks 7, 8 as described above. The corresponding processing is made in parallel for each signal (R, G and B), as is shown in FIG. 2. The block comprising the low-pass and high-pass filters, the gain addition element and the addition block may be referred to as a Y->Y alias suppression block or control unit 3. The gain factors Cᵢ of the respective branch (R, G and B) are selected so that the gain factors C_{R}, C_{G} and C_{B} are equal to one-third of their reciprocal contribution to the total luminance. In the present case (see equation 1), this results in:

$${C}_{R} = \frac{1}{3} \cdot \frac{1}{0.299} {C}_{G} = \frac{1}{3} \cdot \frac{1}{0.587} {C}_{B} = \frac{1}{3} \cdot \frac{1}{0.114} \qquad ( 5 )$$

It shall be noted that, in the model disclosed in FIG. 1, the order of the linear time-invariant blocks can be changed. For example, the anti-alias filtering block F may be moved to a position just in front of the down sampling block.

For example, in an alternative embodiment of this invention, the filter F, the filter LP, the filter HP, with the connected gain Ci and the addition block, as disclosed in FIG. 2, may all be combined in a single filter block F, comprising one filter block per colour, i.e. Filter_R. Filter_G and Filter_B. The filter coefficient are determined by LP, HO and Cr for Filter_R. It shall be noted that the high-pass and the low-pass filters have no relationship with the anti-aliasing filter, the sampling factor or the sampling structure. The aliasing is suppressed if the location of each pixel on the display is properly compensated by a delay before downsampling. It shall be noted in this context that the above sampling factor is equal to the downsampling factor mentioned above. In the present example, the downsampling factor is equal to 3. However, other sampling factors are possible, such as for example 2, 5, 6 (integer scaling) or 2.5, 3.6, 4.6 (non-integer scaling).

Even if the invention is described in detail above, with reference to one preferred embodiment of the invention, the invention is not limited to use in the above described type of display, and the separation filters (high-pass and low-pass) as well as the gain factors are not dependent on the sampling structure of the display. The inventive method are therefore applicable to any sampling structure, provided that the total delay is the same for each branch or channel. For instance, the invention is equally applicable to so-called 2D sampling displays, for example having a delta-nabla structure.

Moreover, it shall be noted that the invention is not limited to RGB displays, but may also be applied in for example four-colour systems, or three-colour systems using another colour combination than R, G and B. In any case, the gain factors should be chosen so that they are inversely proportional to the contribution of each branch or channel to the total display luminance.

Also, it shall be noted that the invention is not only applicable to linear displays but may also be used for displays having a non-linear relationship between the input voltage and the resulting light intensity (gamma).

As indicated above, it shall also be noted that that the invention is applicable both with integer scaling, as exemplified above, and with non-integer scaling. For example, down-scaling by 2.5 may be carried out in the following steps: upsampling by a factor 2; filtering the signal and introducing appropriate delays; and downsampling by a factor 5. The filtering may also be modified according to the high-pass/low-pass idea according to this invention. Such upsampling/filtering/downsampling may for example be efficiently implemented by means of polyphase filtering.

1. A method for improving the perceived resolution of a colour matrix display with at least one pixel, comprising the steps of subdividing an incident colour channel signal (R) to said pixel into a first and second signal component,
applying a gain factor to one of said signal components, and
subsequently recombining said first and second signal components into an exiting, modified colour channel signal.

2. A method according to claim 1, wherein said first and second signal components are a low-pass component and a high-pass component, respectively.

3. A method according to claim 2, wherein said gain factor is applied to said high-pass component.

4. A method according to claim 2, wherein said low-pass component is realised by means of a low-pass filter, and said high-pass component is realised by means of a high-pass filter, said low-pass and high-pass filters being complementary.

5. A method according to claim 1, further comprising the step of:
providing the gain factor, so that the gain factor is inversely proportional to the contribution of the colour channel to the total luminance of the colour matrix display.

6. A method according to claim 1, further comprising the step of:
transmitting said exiting, modified colour channel signal to a delay and up- or downsampling block in order to provide the modified colour channel signal with a suitable delay and scaling.

7. A colour matrix display device having at least one pixel, said pixel being arranged to be controlled by means of an applied colour channel signal, the display device having a control unit comprising:
a subdivision unit, for subdividing an incident colour signal into a first and second signal component,
an gain factor application unit, for applying a gain factor to one of said components, and
a recombination unit, for subsequently recombining said first and second signal components into an exiting, modified colour channel signal, being used to control said pixel.

8. A colour matrix display device as in claim 7, being arranged to perform the method according to claim 1.
